(19) United States
(12) Patent Application Publication
(10) Pub. No.: US 2018/0178640 A1
(43) Pub. Date: Jun. 28, 2018

(54) DOOR WEATHER STRIP FOR AUTOMOBILE

(71) Applicant: TOYODA GOSEI CO., LTD., Kiyosu-shi (JP)

(72) Inventor: Hideo NAGAI, Kiyosu-shi (JP)

(21) Appl. No.: 15/826,938

(22) Filed: Nov. 30, 2017

(30) Foreign Application Priority Data
Dec. 22, 2016 (JP) 2016-248838

(51) Int. Cl. B60J 10/86; E06B 7/23; B60J 10/36; B60J 10/248

(52) U.S. Cl. CPC B60J 10/87; B60J 10/248; B60J 10/36; E06B 7/2305

(57) ABSTRACT

A door weather strip for an automobile, which exhibits excellent sealing properties between a door of the automobile and a door opening portion of a vehicle body with a small door-closing force. The door weather strip includes a base portion and a tubular seal portion. The base portion includes a bottom wall contacting the door, a partition formed in a boundary between the bottom wall and the tubular seal portion, and an interior space formed between the bottom wall and the partition. The tubular seal portion includes a seal wall surrounding an outer periphery thereof, and an interior space inside the seal wall. The partition includes a connection hole connecting the interior space of the base portion to the interior space of the tubular seal portion.

### CROSS-REFERENCE TO RELATED APPLICATIONS

This application is related to and claims priority from Japanese patent application No. 2016-248838, incorporated herein by reference.

### BACKGROUND OF THE INVENTION

### 1. Field of the Invention

The present invention relates to a door weather strip for an automobile, which is adapted to effect a seal between a door of the automobile and a door opening portion of a vehicle body.

### 2. Description of the Related Art

Hereinafter, as shown in FIG. 1, the present invention will be described with reference to door weather strips 10 attached to outer peripheries of doors, each including a door panel 12 and a door frame 14, to effect seals between the doors and a door opening portion 16 of a vehicle body.

As shown in FIG. 2, a seal between the door of the automobile and the door opening portion 16 of the vehicle body is effected by the door weather strip 10 attached to an outer periphery of the door frame 14, etc., and/or an opening weather strip 18 attached to a flange 20 of the door opening portion 16. And a seal between a door glass 22 and the door is effected by a glass run 24 attached in a channel 26 provided in an inner periphery of the door frame 14.

The glass run 24 is attached in the channel 26, and a tip end of the door glass 22 is accommodated in an interior space defined by an outer side wall 28, a bottom wall 30 and an inner side wall 32, which have a generally U-shaped cross-section. And an outer seal lip 34 extending from an end of the outer side wall 28, and an inner seal lip 36 extending from an end of the inner side wall 32 contact an exterior surface and an interior surface of the door glass 22 to effect a seal against the door glass 22.

The opening weather strip 18 is attached to the flange 20 provided in the door opening portion 16 with a trim portion 38 having a generally U-shaped cross-section, and a tubular seal portion 40 contacts an interior side surface of a projecting part 42 of the door frame 14 to effect a seal against the door frame 14.

The door weather strip 10 attached to outer peripheries of the door frame 14 and the door panel 12 of the door includes a base portion 44 and a tubular seal portion 46 formed integrally with the base portion 44 on an upper side thereof. The base portion 44 is fitted in a retainer 48 attached to the outer peripheries of the door panel 12 and the door frame 14. As a result, the base portion 44 is secured to the door panel 12 and the door frame 14.

At this time, the tubular seal portion 46 contacts an interior projecting part in the door opening portion 16 to effect a seal between the door frame 14 and the door opening portion 16. When the door is closed, the tubular seal portion 46 is caught between the door opening portion 16 and the door frame 14, and is consequently deformed. As a result, the pressure in an interior space of the tubular seal portion 46 rapidly rises. Therefore, a door-closing force adapted to close the door rises to deteriorate the door-closing performance.

As shown in FIG. 3, a tubular seal portion 50 of a door weather strip 52 is attached to the outer periphery of the door frame 14 which curves along the outer periphery of the door frame 14. In order to prevent the deformation of the tubular seal portion 50 attached with curving door frame, or the deformation of the tubular seal portion 50 due to the change with time, a partition 54 is provided in an interior space of the tubular seal portion 50 (see Unexamined Japanese Patent Application Publication No. 2003-237379, for example).

By the partition, the interior space of the tubular seal portion 50 is divided, so the sectional area of each space become smaller, and pressure rise of each space at door closing will be higher. Therefore, air vents 56 and 58 are respectively provided in a seal wall 60 and the partition 54 of the tubular seal portion 50.

And, similarly, as shown in FIG. 4, an opening weather strip 62 is attached to the flange 20 with a trim portion 64, a partition 66 is provided in an interior space of a tubular seal portion 68, and air vents 70 and 72 are respectively provided in a seal wall 74 and the partition 66 of the tubular seal portion 68 (see Japanese Patent No. 5014231, for example).

In these conventional examples, the positions of the air vents are restricted because the air vents are provided in the tubular seal portion so there are limitations in terms of the appearance or contact position of the tubular seal portion.

### SUMMARY OF THE INVENTION

Accordingly, it is an object of the present invention to provide a door weather strip for an automobile, of which a door-closing force is made small, and which can exhibit excellent sealing properties between doors and a door opening portion of a vehicle body.

In order to achieve the above-described object, according to a first aspect of the present invention, a door weather strip attached to an outer periphery of a door for effecting a seal between the door and a door opening portion of a vehicle body of an automobile, includes a base portion for attachment to the door, and a tubular seal portion integrally formed with the base portion so as to contact and seal the door opening portion, the base portion includes a bottom wall contacting the door, a partition formed in a boundary between the bottom wall and the tubular seal portion, and an interior space of the base portion, which is formed between the bottom wall and the partition, the tubular seal portion includes a seal wall surrounding an outer periphery thereof and an interior space inside the seal wall, and the partition includes a connection hole connecting the interior space of the base portion to the interior space of the tubular seal portion.

With the arrangement of the first aspect of the present invention, the door weather strip includes the base portion for attachment to the door, and the tubular seal portion integrally formed with the base portion so as to contact and seal the door opening portion. Therefore, where the base portion is attached to the outer periphery of the door, the tubular seal portion contacts the door opening portion when the door is closed, thereby effecting a seal between the door and the door opening portion.

The base portion includes the bottom wall for contacting the door, the partition formed in the boundary between the bottom wall and the tubular seal portion, and the interior space formed between the bottom wall and the partition. By having hollow space in the base portion, the weight of the door weather strip can be reduced and flexibility of the base portion can be improved so that it can be attached curved door frame. Furthermore, the hollow space can keep the shape of the base portion and suppress the abnormal deformation of the tubular seal portion.

The tubular seal portion includes the seal wall surrounding the outer periphery thereof and the interior space inside the seal wall. Therefore, when the door is closed, the seal wall can be bent inwardly of the interior space of the tubular seal portion so as to be bent flexibly along projections of the door opening portion and contact the door opening portion, thereby effecting a seal between the door and the door opening portion.

The partition includes the connection hole for connecting the interior space of the base portion to the interior space of the tubular seal portion. Therefore, when the door is closed, and the seal wall of the tubular seal portion is bent inwardly of the interior space thereof, the volume change rate of the volume of the interior space of the tubular seal portion against the entire volume of the interior space of the tubular seal portion and the interior space of the base portion, which is due to the volume reduction caused by bending when the door is closed, decreases, as compared to the case where no connection hole is provided. As a result, the upper limit of the internal pressure can be suppressed. In addition, air can be released to the interior space of the base portion by way of the connection hole to delay any rapid pressure rise in the interior space of the tubular seal portion, thereby improving the door-closing performance.

According to a second aspect of the present invention, the bottom wall includes a through hole penetrating the bottom wall from the interior space of the base portion to an exterior side thereof, and the through hole is formed at a position extending an axis of the connection hole.

With the arrangement of the second aspect of the present invention, the bottom wall includes the through hole penetrating the bottom wall from the interior space of the base portion to the exterior side thereof, and the through hole is formed at the position extending the axis of the connection hole. Therefore, the through hole and the connection hole can be simultaneously formed so that no special step of drilling the partition is needed.

According to a third aspect of the present invention, the door weather strip is attached to the outer periphery of the door, and a part of the door weather strip, which is located on a side opposite to a door hinge adapted to attach the door to the vehicle body, includes the connection hole.

With the arrangement of the third aspect of the present invention, the door weather strip is attached to the outer periphery of the door, and the part of the door weather strip, which is located on the side opposite to the door hinge adapted to attach the door to the vehicle body, includes the connection hole. When the door is closed, the door is turned around the door hinge so that the turning speed of a side end of the door, which is located on the side opposite to the side where the door hinge is provided, is highest, whereby air can be released from the interior space of the tubular seal portion to the interior space of the base portion by way of the connection hole, and the volume of the compressed interior space of the tubular seal portion increases to delay any rapid pressure rise in the interior space of the tubular seal portion, and improve the door-closing performance.

According to a fourth aspect of the present invention, an attaching clip adapted to attach the door weather strip to the door is provided in the through hole.

With the arrangement of the fourth aspect of the present invention, the attaching clip adapted to attach the door weather strip to the door is provided in the through hole so that no hole adapted to attach the attaching clip is needed to shorten the processing steps.

According to a fifth aspect of the present invention, the connection hole includes a plurality of connection holes arranged at intervals of 10 cm to 15 cm.

With the arrangement of the fifth aspect of the present invention, the connection hole includes a plurality of connection holes arranged at intervals of 10 cm to 15 cm so that a sufficient amount of air can be securely released to the interior space of the base portion by way of the connection holes, and a rapid pressure rise in the interior space of the tubular seal portion can be delayed to improve the door-closing performance.

The partition includes the connection hole for connecting the interior space of the base portion to the interior space of the tubular seal portion so that, when the door is closed, and the tubular seal portion is bent inwardly of the interior space of the tubular seal portion, the volume change rate of the volume of the interior space of the tubular seal portion against the entire volume of the interior space of the tubular seal portion and the interior space of the base portion, which is due to the volume reduction caused by bending when the door is closed, decreases, as compared to the case where no connection hole is provided. As a result, the upper limit of the internal pressure can be suppressed. In addition, air can be released to the interior space of the base portion by way of the connection hole to delay any rapid pressure rise in the interior space of the tubular seal portion, thereby improving the door-closing performance.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a side view of an automobile;

FIG. 2 is a cross-sectional view of a conventional door weather strip attached to a door frame of an automobile;

FIG. 3 is a cross-sectional view of another conventional door weather strip attached to a door frame of an automobile;

FIG. 4 is a cross-sectional view of another conventional door weather strip attached to a door frame of an automobile;

FIG. 5 is a cross-sectional view of one embodiment of a door weather strip in accordance with the present invention, which is attached to a door frame, taken along the line A-A of FIG. 6; and

FIG. 6 is a front view of an entire portion of a door weather strip in accordance with the present invention.

### DETAILED DESCRIPTION OF THE PREFERRED EMBODIMENTS

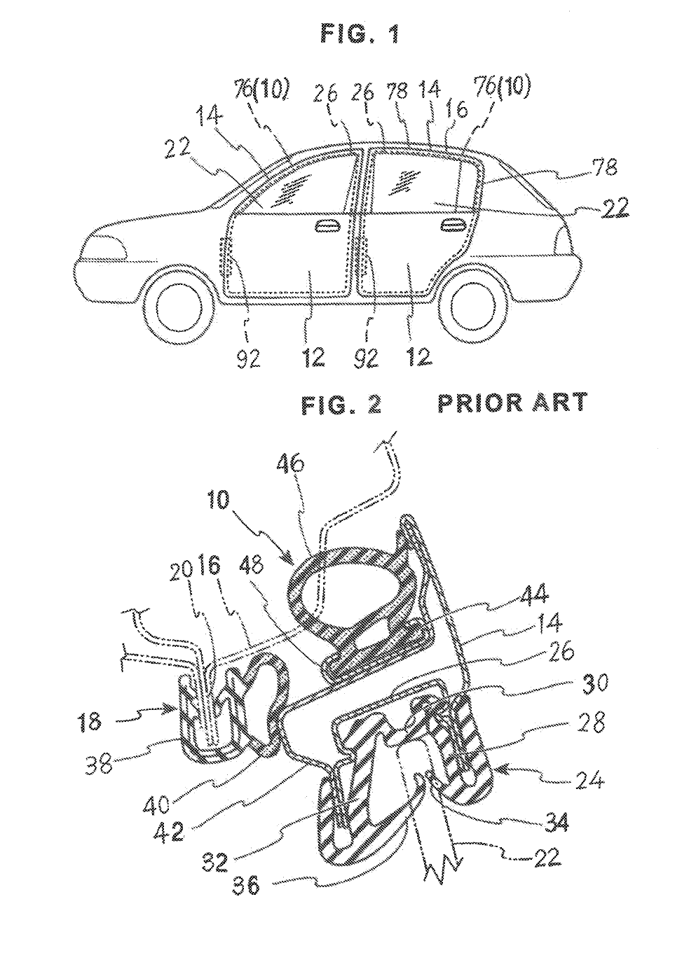

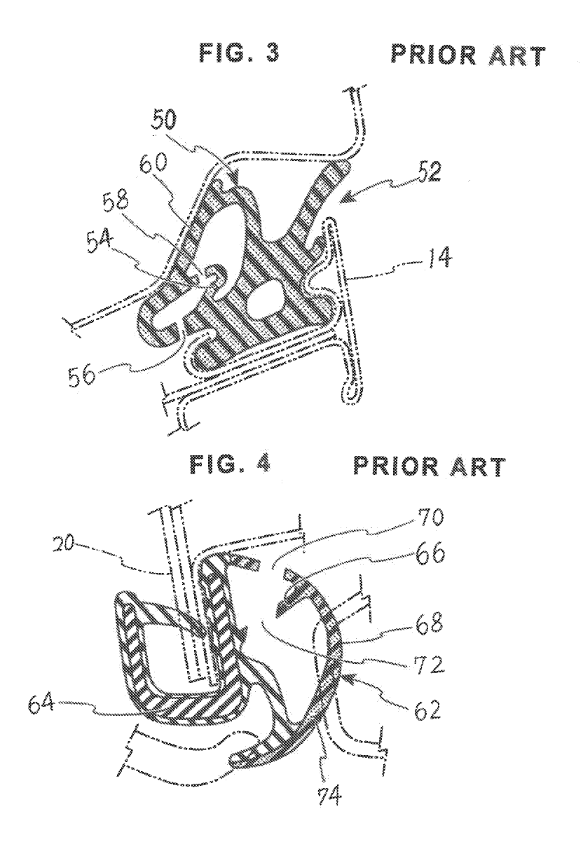

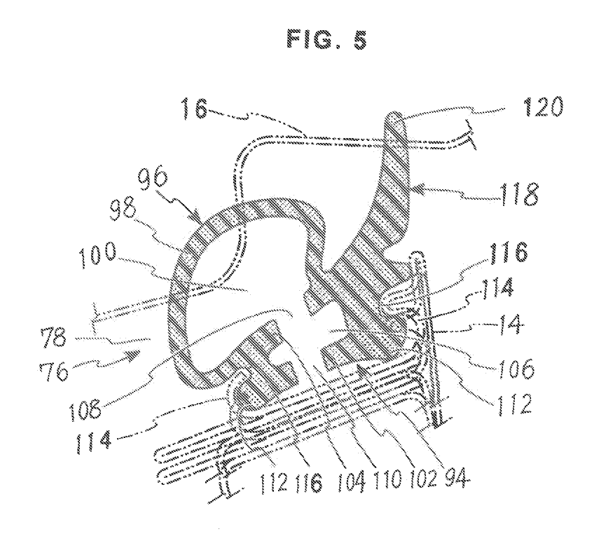

A door weather strip 76 in one embodiment of the present invention will be explained with reference to FIGS. 1, 5 and 6.

FIG. 1 is a side view of an automobile to which the door weather strip 76 of the present invention is attached. The door weather strip 76 is attached to an outer periphery of a door including a door panel 12 and a door frame 14. And a channel 26 is provided along an inner periphery of the door frame 14, and a glass run (not shown) is attached to the channel 26 to guide a door glass 22 as it is raised and lowered.

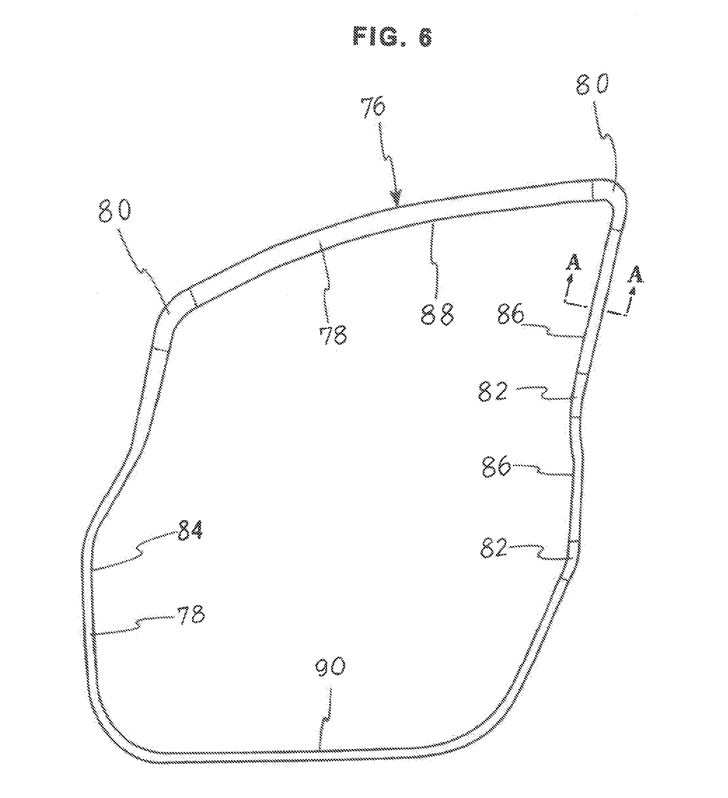

FIG. 5 is a cross-sectional view of the door weather strip 76 in the embodiment of the present invention, which is attached to the door frame 14. FIG. 6 is a front view of the door weather strip 76 in the embodiment of the present invention.

As shown in FIG. 6, the door weather strip 76 in the embodiment of the present invention includes straight sections 78 formed by extrusion, which are respectively connected to corner sections 80 and connection sections 82, so as to be formed into a ring-shaped configuration. The connection between the straight sections 78 and the corner sections 80 or the connection sections 82 can be performed by means of molds or using adhesives.

In the present embodiment, in corners of the door frame 14, the door weather strip 76 includes the corner sections 80 formed by molding so as to conform to the corners of the door frame 14, and the corner sections 80 are respectively connected to the straight sections 78 when molded. Similarly, the molded connection sections 82 are respectively connected to the straight sections 78 when molded.

The straight sections 78 include a front vertical side section 84 attached to a front side of the door, a rear vertical side section 86 attached to a rear side of the door, an upper side section 88 attached to an upper side of the door, and a lower side section 90 attached to a lower side of the door. The front vertical side section 84 is close to a door hinge 92 adapted to attach the door to the vehicle body. The rear vertical side section 86 is attached to the door panel 12 and the door frame 14, which are opposite to the door hinge 92.

As shown in FIG. 5, each straight section 78 of the door weather strip 76 includes a base portion 94 and a tubular seal portion 96 formed integrally with the base portion 94 to contact the door opening portion 16. Each corner section 80 and each connection section 82 of the door weather strip 76 have generally similar configurations to that of each straight section 78.

The tubular seal portion 96 includes a seal wall 98 surrounding an outer periphery thereof, and an interior space 100 inside the seal wall 98. When the door is closed, the seal wall 98 contacts the door opening portion 16, and the interior space 100 of the tubular seal portion 96 can be bent inwardly thereof. The seal wall 98 flexibly bends to conform to the configuration of a projecting part of the door opening portion 16, and contacts the door opening portion 16, thereby effecting a seal between the door and the door opening portion 16. At this time, the interior space 100 of the tubular seal portion 96 is compressed to increase the internal pressure thereof.

In the present embodiment, the base portion 94 includes a bottom wall 102 contacting the door frame 14 of the door, a partition 104 formed in a boundary between the base portion 94 and the tubular seal portion 96 generally in parallel to the bottom wall 102, and an interior space 106 defined by the bottom wall 102 and the partition 104. The bottom wall 102 and the partition 104 are integrally formed so as to surround the interior space 106 of the base portion 94.

By virtue of the provision of the interior space 106, the weight of the entire door weather strip 76 can be reduced, and the flexibility of the base portion 94 is improved, whereby curving parts of the base portion 94 can be bent along curving parts of the door frame 14 when attached thereto.

The partition 104 includes a connection hole 108 in a connection between the interior space 106 and the interior space 100. When the door is closed, the seal wall 98 of the tubular seal portion 96 may be bent inwardly of the interior space 100 to increase the internal pressure thereof. By virtue of the connection hole 108, the volume change rate of the volume of the interior space 100 of the tubular seal portion 96 against the entire volume of the interior space 100 and the interior space 106, which is due to the volume reduction caused by bending when the door is closed, decreases, as compared to the case where no connection hole 108 is provided. As a result, the upper limit of the internal pressure can be suppressed.

In addition, air can be released from the interior space 100 into the interior space 106 by way of the connection hole 108, and the volume of the compressed interior space 100 increases to delay a rapid pressure rise in the interior space 100 of the tubular seal portion 96.

Consequently, when the door is closed, a reaction force exerted by the tubular seal portion 96 against the door can be reduced, thereby decreasing the force adapted to close the door to improve the door-closing performance. Where the connection hole 108 is provided, the increase of the internal pressure in the interior space 100 can be reduced by around 10 to 30 percent, as compared to the case where no connection hole is provided.

In the present embodiment, as shown in FIG. 1, the door hinge 92 is attached to the vehicle body on the front side of the door. The door weather strip 76 is arranged such the front vertical side section 84 thereof is attached in the vicinity of the door hinge 92 while the rear vertical side section 86 is attached to the position opposite to the door hinge 92. The connection hole 108 is provided in at least the rear vertical side section 86 of the door weather strip 76.

When the door is closed, the door turns around the door hinge 92 so that the door weather strip 76 along the part opposite to the door hinge 92 contacts the door opening portion 16 at the highest speed to close the door. As a result, as shown in FIG. 6, the pressure of the interior space 100 of the rear vertical side section 86 of the door weather strip 76 rapidly rises to a highest pressure, thereby increasing the reaction force against the door.

In the present embodiment, the door hinge 92 is attached to the front side of the door. If the door hinge 92 is provided on the rear side of the door, the front vertical side section 84 contacts the door opening portion 16 at the highest speed so that the connection hole 108 is provided in at least the front vertical side section 84 of the door weather strip 76.

As the connection hole 108 is provided in the rear vertical side section 86 of the door weather strip 76, as described above, when the door is closed, the part of the door weather strip 76, which contacts the vehicle body at the highest speed, can release air from the interior space 100 to the interior space 106 by way of the connection hole 108, whereby the volume change rate is suppressed small to delay the rapid pressure rise in the interior space 100, and decrease the reaction force exerted when the door is closed. As a result, the door-closing performance can be improved.

The connection hole 108 can be provided in each of the front vertical side section 84, the upper side section 88 and the lower side section 90. In these cases, air can be further released from the interior space 100 to the interior space 106 by way of the connection hole 108, whereby the volume change rate is suppressed small, thereby improving the door-closing performance.

It is preferable that a plurality of connection holes 108 are arranged at intervals of 10 cm to 15 cm. In this case, by virtue of the connection holes 108, a sufficient amount of air can be securely released to the interior space 106, and a rapid pressure rise in the interior space 100 can be delayed to improve the door-closing performance.

Where the interval is less than 10 cm, the number of the connection holes 108 increases so that the drilling work takes labor and time, and the stiffness of the partition 104 lowers. In contrast, where the interval exceeds 15 cm, air cannot be sufficiently released from the interior space 100 to the interior space 106 by way of the connection holes 108 so that the effect of delaying a rapid pressure rise in the interior space 100 is lowered.

It is preferable that a plurality of through holes 110 are similarly arranged at intervals of 10 cm to 15 cm so as to correspond to the positions of the connection holes 108. In this case, both the through holes 110 and the connection holes 108 can be simultaneously formed by drilling so that no special drilling work for the partition 104 is needed.

And an attaching clip (not shown) adapted to attach the door weather strip 76 to the door frame 14 of the door can be provided in each through hole 110 for attaching. In this case, no hole adapted to attach the attaching clip is separately needed to shorten the processing process.

A projection 112 is provided at each end of a surface of the bottom wall 102, which contacts the door frame 14. Each projection 112 contacts a retainer 114 of the door frame 14 to effect a seal between the base portion 94 and the door frame 14.

A recessed part 116 is provided at each end of a surface of the bottom wall 102 on the side of the partition 104. A tip end of the retainer 114 bent from the door frame 14 is engaged in each recessed part 116 to retain the base portion 94.

A seal lip 118 is formed on an exterior side of a connection between the partition 104 and the seal wall 98. When the door is closed, a tip end 120 of the seal lip 118 contacts the door opening portion 16. As a result, the seal lip 118 and the tubular seal portion 96 can effect a double seal against the door opening portion 16.

In accordance with the present invention, the door weather strip 76 is composed of a sponge material, and examples of the sponge material include a sponge material of an EPDM rubber, and a sponge material of a thermoplastic elastomer.

After the sponge material is extruded, it is heated and cut to prescribed dimensions, thereby forming the straight sections 78 of the door weather strip 76. Then, the through hole 110 and the connection hole 108 are opened from the bottom wall 102 of the base portion 94 at a prescribed part of each cut straight section 78 by drilling, etc.

Furthermore, the corners 80 are formed by molding, and simultaneously, the straight sections 78 are connected thereto, thereby forming the door weather strip 76.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. A door weather strip attached to an outer periphery of a door to effect a seal between the door and a door opening portion of a vehicle body of an automobile, comprising:
a base portion for attachment to the door; and
a tubular seal portion integrally formed with the base portion to contact and seal the door opening portion,
wherein the base portion comprises a bottom wall contacting the door, a partition formed in a boundary between the bottom wall and the tubular seal portion, and an interior space formed between the bottom wall and the partition,
the tubular seal portion comprises a seal wall surrounding an outer periphery of the tubular seal portion and an interior space inside the seal wall, and
the partition comprises a connection hole connecting the interior space of the base portion to the interior space of the tubular seal portion.

2. The door weather strip according to claim 1,
wherein the bottom wall comprises a through hole penetrating the bottom wall from the interior space of the base portion to an exterior side thereof, and the through hole is formed at a position extending an axis of the connection hole.

3. The door weather strip according to claim 1,
wherein the door weather strip is attached to the outer periphery of the door, and a part of the door weather strip, which is located on a side opposite to a door hinge adapted to attach the door to the vehicle body, comprises the connection hole.

4. The door weather strip according to claim 1,
wherein an attaching clip adapted to attach the door weather strip to the door is provided in the through hole.

5. The door weather strip according to claim 1,
wherein the connection hole comprises a plurality of connection holes arranged at intervals of 10 cm to 15 cm.
